(19) United States
(12) Patent Application Publication
(10) Pub. No.: US 2006/0199272 A1
(43) Pub. Date: Sep. 7, 2006

(54) Compounds generating a dynamic nuclear polarisation process

(76) Inventor: Lars-Goran WISTRAND, Malmo (SE)

Correspondence Address: GE HEALTHCARE, INC., IP DEPARTMENT, 101 CARNEGIE CENTER, PRINCETON, NJ, 08540-6231, US

(21) Appl. No.: 10/552,133

(22) PCT Filed: Apr. 15, 2004
(86) PCT No.: PCT/NO04/00107

§ 371 Date: Oct. 6, 2005

(30) Foreign Application Priority Data
Apr. 15, 2003 (NO) 20031736

(51) Int. Cl. G01N 24/00

(52) U.S. Cl. 436/173

(57) ABSTRACT

The present invention relates to radicalas for use in a dynamic nuclear polarisation (DNP) of a sample. The invention further relates to a dynamic nuclear polarisation of a mixture comprising these radicals.

The present invention relates to radicals for use in a dynamic nuclear polarisation (DNP) of a sample. The invention further relates to a dynamic nuclear polarisation of a mixture comprising these radicals.

The dynamic nuclear polarisation (DNP) technique is used to enhance the NMR signal of a sample comprising NMR active nuclei, whereby polarisation of the sample is effected by a DNP agent, i.e. a paramagnetic compound. During the DNP process, energy, normally in the form of microwave radiation, is provided, which will initially excite the paramagnetic compound. Upon decay to the ground state, there is a transfer of polarisation from the unpaired electron of paramagnetic compound to the NMR active nuclei of the sample. Generally, a moderate or high magnetic field and a very low temperature are used in the DNP process, e.g. by carrying out the DNP process in liquid helium and a magnetic field of about 1 T or above. Alternatively, a moderate magnetic field and any temperature at which sufficient polarisation enhancement is achieved may be employed. The DNP technique is for example described in WO-A-98/58272 and in WO-A-01/96895, both of which are included by reference herein.

Free radicals may suitably be used as paramagnetic compounds in the DNP process. In WO-A-98/58272 it is described that free radicals exhibiting low inherent ESR linewidths are preferred in the DNP process and that such radicals might be prepared in situ from a radical precursor. Examples of such free radicals are triarylmethylradicals, nitrogen-centred radicals, stable carbon centred radicals and metal ions with unpaired electrons. However, the presence of such relatively stable radicals causes problems in the NMR analysis of the sample subsequent to the polarisation process: By spin-nucleus interactions, broadening of the NMR signals occurs, which in turn causes loss of sensitivity. In some cases, the resolution of the spectrum is lower than expected. Further, relaxation times of the nuclei to be analysed may be shortened due to the presence of radicals. As a consequence, polarisation decreases and a lower signal is obtained in the NMR analysis.

WO-A-00/23797 describes the use of HBr and HI as radical precursors and the generation of radicals from these compounds by irradiation with ultraviolet light. The radicals are used in the dynamic nuclear polarisation of ¹²⁹Xe. It is stated that after the polarisation is completed, the photo-induced radicals are eliminated.

Hence, there is a need for paramagnetic compounds for use in a DNP process which effect high polarisation of the sample without causing the negative effects described above.

It has now been found that the use of radicals, which are generated in situ form a radical precursor and decompose to non-radical species at temperatures from about 5 K to about 273 K is especially useful for the dynamic nuclear polarisation of a sample and the subsequent NMR analysis of said sample.

The present invention provides radicals for use in the dynamic nuclear polarisation of a sample wherein the radicals are generated in situ from radical precursors and decompose to non-radical species at temperatures from about 5 K to about 273 K.

The radicals according to the invention are stable during the DNP process as the DNP temperature is generally very low, preferably about the temperature of liquid helium (4.2 K) or less, more preferably 1.5 K or less, especially preferably 1 K or less. As the NMR analysis of the sample is generally carried out at temperatures above the DNP temperature, preferably above 273 K, particularly preferably at room temperature, there are no radicals present in the sample during the NMR analysis. Hence, problems due to the presence of radicals like broadening of the NMR signals, loss of sensitivity, low resolution of the spectrum and rapid loss of polarisation can be avoided.

In a preferred embodiment, the radicals according to the invention decompose to non-radical species at temperatures from about 50 K to about 253 K, particularly preferably at temperatures above about 77 K.

In a preferred embodiment, the radical precursors used to generate the radicals according to the invention are photolabile organic compounds or organic compounds comprising a photolabile group and the radicals are generated by photolysis.

Preferred photolabile organic compounds are compounds selected from the group consisting of R¹—X, R¹—S—R², R¹—Se—R², R¹—N═N—R², R¹—O—O—R², R¹—ONO, R¹—OX and R¹CO—O—O—COR², wherein R¹ and R² are identical or different straight chain or branched alkyl, aryl or aralkyl groups, and X is Cl, Br or I. Said R¹ and R² groups may be unsubstituted. Alternatively, said R¹ and R² groups may be substituted by one or more organic residues like OH, CN, NO₂, OR¹ and F and/or may comprise heteroatoms like O or N. In a preferred embodiment, R¹ and R² are identical.

Preferred photolabile groups are selected from the group consisting of —R¹—X, —R¹—S—R², R¹—S—R²—, —R¹—Se—R², R¹—Se—R²—, —R¹—N═N—R², R¹—N═N—R²—, —R¹—O—O—R², R¹—O—O—R²—, —R¹—ONO, —R¹—OX, R¹CO—O—O—R²—, —R¹CO—O—O—COR² and R¹CO—O—O—COR²—, wherein R¹ and R² are identical or different straight chain or branched alkyl, aryl or aralkyl groups, and X is Cl, Br or I. Said R¹ and R² groups may be unsubstituted. Alternatively, said R¹ and R² groups may be substituted by one or more organic residues like OH, CN, NO₂, OR¹ and F and/or may comprise heteroatoms like O or N. In a preferred embodiment, R¹ and R² are identical.

Specific examples of photolabile compounds are:

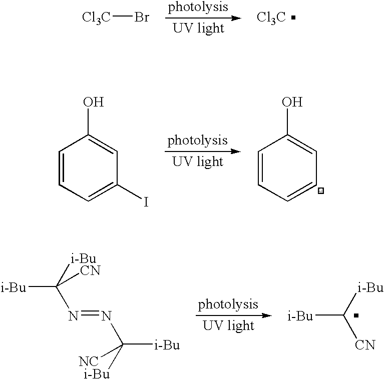

Generally, photolysis is carried out using either visible or ultraviolet light or light of shorter wavelength. The choice of wavelength for the photolysis depends on the nature of the photolabile organic compound or group. Preferably, wavelengths in the range of about 200 to 300 nm are chosen for the photolysis.

The advantage of the radical precursors described in the preceding paragraphs is that there is a wide selection of R¹ and R² groups to choose from. The nature of these groups determines the lifetime of the radical generated from said precursors. In case of a radical with a relatively long lifetime, the radical concentration needed in the DNP process is lower than the radical concentration needed in case of a radical having a short lifetime. Hence, it is possible to adjust the radical concentration in the DNP process. The nature of the R¹ and R² groups also influences the EPR (electron paramagnetic resonance) spectrum of the radical precursor, which can be used to optimise the DNP effect. The DNP effect for a given sample is not easy to predict and results depend very much on the radical structure. Consequently, using radical precursors with different R¹ and R² groups makes it possible to “tailor” a radical precursor with specific R¹ and R² groups for an optimal DNP effect for a given sample. Particularly preferred photolabile organic compounds or organic compounds comprising a photolabile group are azobisisobutyronitrile, tert.-butyl nitrite, tert.-butyl hypochlorite, dibenzoylperoxide and di-tert.-butylperoxide.

In another preferred embodiment, the radical precursors used to generate the radicals according to the invention are organic solvents and the radicals are generated using high-energy radiation.

Preferred solvents are selected from the group consisting of water, alcohols, ethers, hydroxylated ethers and hydroxylated esters.

The advantage of using solvents as radical precursors to generate the radicals according to the invention is that the compounds present in the DNP mixture can be limited to the sample and said solvent. However, high-energy irradiation of solvents often results in the simultaneous generation of several different radical species which might make the DNP process more difficult to perform since this process relies on using a radical with a known and well-defined EPR spectrum. Hence, it is particularly preferred to use solvents from which a single radical is generated upon high-energy radiation. Examples of such particularly preferred solvents are water, methanol, 1,2 propanediol, methoxyethanol, glycol and glycerol. For instance, hydroxyl radicals are generated from water and hydroxymethyl radicals are generated from methanol upon high-energy radiation. 1,2 propanediol, glycol and glycerol are glass forming compounds which means that they do not crystallise at low temperatures. The presence of such glass forming compounds in the DNP process ensures the homogenous distribution of radicals and sample in the frozen mixture, which is important to achieve a high DNP effect.

Generally, high-energy radiation can be carried out using gamma radiation or X-ray radiation.

In a particularly preferred embodiment, the radical precursors used to generate the radicals according to the invention are photolabile organic compounds or organic compounds comprising a photolabile group and the radicals are generated by photolysis.

The amount of radical is small, generally less than the amount of sample to be polarised.

The generation of the radical may be carried out before the DNP process either outside the DNP magnet at temperatures above the DNP temperature or inside the DNP magnet at the proper DNP temperature.

For radicals with sufficient stability at higher temperatures than the DNP temperature, e.g. radicals that are stable at temperatures above 5K, the radical generation is preferably carried out before the DNP process outside the DNP magnet. Generally, a mixture comprising the sample and the radical precursor is kept at a certain temperature which is useful for generating the radical from the precursor and which is below the decomposition temperature of the radical to a non-radical species. After the radical generation, the mixture is transferred into the DNP magnet, where it is cooled to the DNP temperature before the polarisation process is carried out. There are several ways known in the art how to keep the mixture at this certain temperature, e.g. by cooling the mixture on ice or using liquid air, liquid nitrogen or liquid helium to achieve lower temperatures.

In a preferred embodiment of the invention, the radicals decompose to non-radical species at temperatures above about 77 K, which is the temperature of liquid nitrogen. In one embodiment the radical is generated outside the DNP magnet by photolysis of a mixture comprising the sample and a photolabile organic compound or an organic compound comprising a photolabile group which is frozen in liquid nitrogen. After photolysis, the mixture is transferred into the DNP magnet, where it is cooled to the DNP temperature before the polarisation process is carried out. In another embodiment, the radical is generated outside the DNP magnet by freezing a mixture comprising the sample and a solvent in liquid nitrogen and irradiating the frozen mixture with high-energy radiation. After the radical generation, the mixture is transferred into the DNP magnet, where it is cooled to the DNP temperature before the polarisation process is carried out.

In a particularly preferred embodiment, the radical is generated outside the DNP magnet by photolysis of a mixture comprising the sample and a photolabile organic compound or an organic compound comprising a photolabile group which is frozen in liquid nitrogen.

Preferred photolabile organic compounds and photolabile groups are described on page 3 of this application. The advantage of using those compounds as radical precursors is that there is a wide selection of R¹ and R² groups to choose from, which determine the stability of the radicals generated from those compounds. Hence, it is possible to “tailor” precursors from which radicals could be generated that are stable at temperatures of about 77 K.

In another embodiment, the generation of the radicals according to the invention is carried out inside the DNP magnet at the proper DNP temperature. A DNP system generally comprises a magnet with field strength of 0.1-25 T or more that is placed in a low loss cryostat in order to achieve optimal cryogenic hold times. For magnetic fields above ca. 2 T the magnet may be superconducting. For lower fields simpler magnets are suitable. An especially preferred DNP system consists of a superconducting magnet designed for a field-strength of 2-25 T. The magnet is placed in an ultra low loss cryostat to achieve optimal cryogenic hold time. The field homogeneity required is sample dependent, but will typically have to be ±0.2 mT over the sample volume. This can be achieved by providing field shims even for large samples. Correspondingly, the stability of the field during polarisation should be better than the homogeneity criterion, i.e. the field drift should be less than the inhomogeneity. The magnet is designed to accommodate a low temperature space to cool the sample. The preferred superconducting magnet cryostat is preferably provided with a pumped helium bath or at least a cold space in the bore of the magnet. The helium bath may be contained in a tube that is thermally insulated (e.g. vacuum insulated) from the magnet helium reservoir but connected to it by a capillary to allow filling from the magnet reservoir. The low temperature space may simply be a cylinder (made from thin-walled stainless steel or copper or another non-magnetic material or combinations thereof) with the lower end closed. In order to obtain the lowest possible temperatures and lowest cryogenic consumption, the low temperature space is preferably placed in vacuum inside the helium can of the superconducting magnet and the low temperature cylinder can preferably be thermally anchored at appropriate places in the bore, for example to the helium vapour-cooled shield and the liquid nitrogen-cooled shield or the like. The low temperature cylinder is preferably connected to the helium can through a capillary at its base. The flow of helium may be controlled by a needle valve regulated from exterior, manually or automatically by computer control means or the like. The flow of helium into the helium bath may be controlled by a motorised needle valve. The level of the liquid can be monitored, e.g. by an Allen Bradley carbon resistor meter, and the needle valve controlled manually or automatically to maintain a fixed level. In order to achieve lower temperatures of the order of 1 K (⁴He), the bath can be pumped and the temperature of the bath can be ascertained through the helium vapour pressure measured, for example, by an absolute capacitance transducer or Pirani element. If cooled by gas then a temperature measurement can be used to control the needle valve. The cryogen could also be supplied from an external reservoir. Closed cycle refrigerators (‘cryogen free’) could also be envisaged, both for magnet cooling and cooling of the cold space. Such DNP systems are known in the art and, for example, described in WO-A-02/36005, which is enclosed herein by reference.

The sample is polarised by microwave irradiation at the proper frequency. A microwave arrangement is provided for irradiation. The microwave arrangement can be implemented in a number of ways. For lower frequencies (less than ca. 200 GHz) a wave-guide may be used to guide the waves to the sample space. At higher frequencies quasi-optical methods can be employed. The sample space is preferably constructed as a resonant microwave structure. The microwave structure is preferably configured to allow easy placement and exchange of samples and an efficient cooling of samples.

If the radicals according to the invention are generated inside the DNP magnet, a DNP system as described in FIG. 1 of WO-A-02/36005 is preferably used. Briefly, such a system comprises a cryostat containing a polarising means preferably consisting of a microwave chamber connected by a wave guide to a microwave source in a central bore surrounded by magnetic field producing means such as a superconducting magnet. A sample introducing means such as a removable sample-transporting tube is preferably contained inside the bore and a sample-retaining cup is preferably fitted over the lower end of the sample-transporting tube. The system further contains means for applying light or high-energy radiation to the sample within the sample-retaining cup. In a preferred embodiment, light is applied to the sample from a light source mounted outside the DNP system, i.e. the cryostat, and the light is applied to the sample through an optical fibre, which extends from the light source to the sample retaining cup.

In order to generate the radicals according to the invention from a radical precursor inside the DNP magnet, a mixture of the sample and the radical precursor is placed into the sample-retaining cup and introduced into the DNP system. In a next step, the means for applying light or high-energy radiation are activated and light or high-energy activation is applied to the mixture, whereby radicals are generated from the radical precursor present in the mixture.

Beside the radicals according to the invention and the sample, the mixture used in the DNP process may comprise other compounds. Suitable other compounds are for instance glass forming compounds, i.e. compounds forming amorphous glasses when the mixture is frozen, or solvents.

Glass forming compounds like glycerol, propanediol or glycol ensure the homogenous distribution of radicals and sample in the frozen mixture, which is important to achieve a high DNP effect.

Solvents are preferably used when the polarised sample is used in an in vitro application. NMR based assays using polarised samples, e.g. ligands and/or target molecules, can be used to study ligand-target interaction in a drug discovery process. Such assays are very sensitive as the NMR signal from the sample is enhanced by the polarisation process. Hence, it is possible to use very small sample amounts and volumes in the DNP process. However, for the subsequent NMR analysis larger volumes must be used and it is thus preferred to use a solvent in the polarisation process rather than to add the solvent after the polarisation process. Suitable solvents are for instance solvents, which are useful to study interaction between the polarised sample and one or more other molecules. Examples of such solvents are deuterated or non-deuterated aqueous buffers, which may contain small amounts of organic solvents like DMSO, methanol or other alcohols or carboxylic acids like acetic acid. However, the use of solvents is less preferred when the sample is used in an in vivo application, e.g. as a contrast agent for magnetic resonance imaging. In this case, further dilution of the sample is not desirable and the use of solvents could also cause safety problems.

The magnetic field strength used in the DNP process should be as high as possible, suitably higher than 0.1 T, preferably higher than 1 T, more preferably 5 T or more, especially preferably 15 T and more and most preferably 20 T and more. Preferably, the polarisation should 1% or more, more preferably 10% and more, especially preferably 25% and more and most preferably 50% and more.

After the DNP process, the sample is taken out from the DNP magnet. NMR analysis of the polarised sample is preferably carried out in the liquid phase, thus the sample has to be melted or dissolved in a suitable solvent. The melting or dissolution is preferably done quickly in order to lose as little of the polarisation as possible. Suitable ways of melting the sample are described in WO-A-02/36005.

In another aspect, the invention relates to the dynamic nuclear polarisation (DNP) of a mixture comprising a sample and a radical, wherein the radical is generated in situ from a radical precursor and decomposes to a non-radical species at temperatures from about 5 K to about 273 K. In a preferred embodiment, said mixture further comprises a solvent and/or a glass forming compound

In another preferred embodiment, the generation of the radical is carried out outside the DNP magnet and the mixture is transferred into the DNP magnet after the radical generation. Preferably, the radical is generated by photolysis of a mixture frozen in liquid nitrogen, wherein the mixture comprises the sample and a photolabile organic compound or an organic compound comprising a photolabile group. In another preferred embodiment, the radical is generated by freezing a mixture comprising the sample and a solvent in liquid nitrogen and irradiating the frozen mixture with high-energy radiation.

### EXAMPLES

### Example 1

A solution is prepared from glycerol (0.15 ml), water (0.05 ml) 1-¹³C-glycine (0.75 mg, 0.01 mmol) and benzoyl peroxide (0.24 mg, 0.001 mmol) and the solution is frozen to droplets in liquid nitrogen. The droplets are then transferred into a magnet (3.5 T) with a probe temperature of 1.2 K. The magnet is provided with means of providing microwave irradiation and means of providing ultraviolet irradiation to the sample. The sample is irradiated with UV light (254 nm) for a period of the time (depending on the energy of the light source); the UV light is turned off and irradiation with microwaves (about 94 GHz) is then commenced to polarize the sample. After a period of polarization of the ¹³C-labelled sample, the microwave irradiation is turned off and the sample is dissolved by injection of hot water, quickly transferred to a NMR instrument and analysed. The signal enhancement obtained is 5-500 times the signal of the sample without carrying out the polarization.

1. Radical for use in a dynamic nuclear polarisation process of a sample wherein the radical is generated in situ from a radical precursor and decomposes to a non-radical species at temperatures from about 5 K to about 273 K.

2. Radical according to claim 1 wherein the radical decomposes to a non-radical species at temperatures from about 50 K to about 253 K.

3. Radical according to claim 1 wherein the radical decomposes to a non-radical species at temperatures above about 77 K.

4. Radical according to claim 1 wherein the radical precursor is a photolabile organic compound or an organic compound comprising a photolabile group and the radical is generated by photolysis.

5. Radical according to claim 4 wherein the radical precursor is a photolabile organic compound selected from the group consisting of R¹—X, R¹—S—R², R¹—Se—R², R¹—N═N—R², R¹—O—O—R², R¹—ONO, R¹—OX and R¹CO—O—O—COR², wherein R¹ and R² are identical or different straight chain or branched alkyl, aryl or aralkyl groups, and X is Cl, Br or I.

6. Radical according to claim 4 wherein the radical precursor is an organic compound comprising a photolabile group, the photolabile group is selected from the group consisting of —R¹—X, —R¹—S—R², R¹—S—R²—, —R¹—Se—R², R¹—Se—R²—, —R¹—N═N—R², R¹—N═N—R²—, —R¹—O—O—R², R¹—O—O—R²—, —R¹—ONO, —R¹—OX, R¹CO—O—O—R²—, —R¹CO—O—O—COR² and R¹CO—O—O—COR²—, wherein R¹ and R² are identical or different straight chain or branched alkyl, aryl or aralkyl groups, and X is Cl, Br or I.

7. Radical according to claim 4 wherein R¹ and R² are identical.

8. Radical according to claim 4 wherein the radical precursor is selected from the group consisting of azobisisobutyronitrile, tert.-butyl nitrite, tert.-butyl hypochlorite, dibenzoylperoxide and di-tert.-butylperoxide.

9. Radical according to claim 4 wherein the photolysis is carried out at wavelengths in the range of about 200 to 300 nm.

10. Radical according to claim 1 wherein the radical precursor is a solvent and the radical is prepared in situ using high-energy radiation.

11. Radical according to claim 10 wherein the radical precursor is selected from the group consisting of water, methanol, 1,2 propanediol, glycol and glycerol.

12. Radical according to claim 10 wherein the high-energy radiation is X-ray radiation or gamma radiation.

13. Dynamic nuclear polarisation (DNP) of a mixture comprising a sample and a radical, wherein the radical is generated in situ from a radical precursor and decomposes to a non-radical species at temperatures from about 5 K to about 273 K.

14. Dynamic nuclear polarisation according to claim 13 wherein the generation of the radical is carried out outside the DNP magnet and the mixture is transferred into the DNP magnet after the radical generation.

15. Dynamic nuclear polarisation according to claim 14 wherein the radical is generated by photolysis of a mixture frozen in liquid nitrogen, the mixture comprising the sample and a photolabile organic compound or an organic compound comprising a photolabile group.

16. Dynamic nuclear polarisation according to claim 14 wherein the radical is generated by freezing a mixture comprising the sample and a solvent in liquid nitrogen and irradiating the frozen mixture with high-energy radiation.

17. Dynamic nuclear polarisation according to claim 13 wherein the mixture further comprises a solvent.

18. Dynamic nuclear polarisation according to claim 13 wherein the mixture further comprises a glass forming compound.
